(19) United States
(12) Patent Application Publication
(10) Pub. No.: US 2022/0234472 A1
(43) Pub. Date: Jul. 28, 2022

(54) SYSTEMS AND METHODS FOR PRE-HEATING BATTERIES

(71) Applicant: Rivian IP Holdings, LLC, Plymouth, MI (US)

(72) Inventors: Boru Wang, Torrance, CA (US); Chia-Chou Yeh, Torrance, CA (US); Kang Wang, Palos Verdes Estates, CA (US); Dang Dang, Garden Grove, CA (US); Steven Schulz, Torrance, CA (US); Silva Hiti, Redondo Beach, CA (US)

(21) Appl. No.: 17/158,696

(22) Filed: Jan. 26, 2021

(51) Int. Cl. B60L 58/27; H02P 21/16; H02P 21/22; H02P 27/12; H01M 10/615; B60L 50/60

(52) U.S. Cl. CPC B60L 58/27; H02P 21/16; H02P 21/22; B60L 2240/545; H01M 10/615; B60L 50/60; H01M 2220/20; H02P 27/12

(57) ABSTRACT

Various disclosed embodiments include illustrative drive unit controllers, drive units, and vehicles. In an illustrative embodiment, a drive unit controller includes a first component configured to receive heat request and vehicle status information. A second component is configured to initiate a battery heat generation mode responsive to the received heat request and the vehicle status information.

### INTRODUCTION

The present disclosure relates to electric vehicle battery systems. The statements in this section merely provide background information related to the present disclosure and may not constitute prior art.

Battery-powered devices lose operational capabilities, such as battery life, when the batteries operate below an optimum temperature range. For example, electric vehicles may experience lower battery output when the vehicle is located in a cold environment. The present disclosure provides a solution for resolving this by utilizing a battery heating device within the vehicle in order to maintain the batteries at an acceptable temperature.

### BRIEF SUMMARY

Various disclosed embodiments include illustrative drive unit controllers, drive units, and vehicles.

In an illustrative embodiment, a drive unit controller includes a first component configured to receive a heat request and vehicle status information. A second component is configured to initiate a battery heat generation mode responsive to the received heat request and the vehicle status information.

In another illustrative embodiment, a drive unit includes an electric motor, an inverter configured to control operation of the electric motor, and a drive unit controller. The drive unit controller includes a first component configured receive to a heat request and vehicle status information and a second component configured to generate a motor instruction responsive to the received heat request and the vehicle status information and send the motor instruction to an inverter of an associated drive unit, the motor instruction being configured to cause a motor commanded by the inverter to operate in a zero-torque mode of operation.

In another illustrative embodiment, a vehicle includes a vehicle status system configured to generate vehicle status information, a battery system configured to generate battery temperature information, a thermal management system configured to generate a heat request in response to the battery temperature information and transfer heat to the battery system, a drive unit configured to receive power from the battery system, and a drive unit controller. The drive unit controller includes a first component configured to receive a heat request and vehicle status information and a second component being configured to generate a motor instruction responsive to the received heat request and the vehicle status information, the motor instruction including a current magnitude value and a current vector direction value, and send the motor instruction to an inverter of an associated drive unit, the motor instruction being configured to cause a motor commanded by the inverter to operate in a zero-torque mode of operation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a block diagram of an illustrative system.

FIG. 2 is a flow diagram of an illustrative process performed by the system of FIG. 1.

FIG. 3 is a chart of operational values of components of the system shown in FIG. 2.

FIG. 4 is a flow diagram of an illustrative process performed by the system of FIG. 1.

FIG. 5 is a chart of operational values of components of the system that performs the process shown in FIG. 4.

FIG. 6 is a chart of operational values of components of the system that performs the process shown in FIG. 4.

FIG. 7 is a flow diagram of an illustrative process performed by the system of FIG. 1.

FIG. 8 is a dq-axis current plane for a permanent magnet motor included in the system shown in FIG. 1.

FIG. 9 is a flow diagram of an illustrative process performed by the system of FIG. 1.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative drive unit controllers, drive units, and vehicles. In such embodiments, illustrative systems and methods may pre-heat vehicle batteries before vehicle operation, when desired, in order to help contribute to a goal of improving operation of an electric vehicle. The operations described below may occur while a vehicle is being charged or just prior to a request or a prediction to operate (that is, drive) the vehicle.

Given by way of non-limiting overview, in various embodiments an illustrative drive unit controller initiates a battery heat generation mode responsive to received a heat request from a thermal management system and vehicle status information from a vehicle status system. In the battery heat generation mode, the drive unit controller instructs an inverter to drive a motor in a zero-torque mode of operation. The controller instruction results in a 3-phase current vector having an angular value located along a main flux direction associated with the motor. The drive unit controller stops the battery heat generation mode if the heat request drops to zero. If the motor or inverter temperature nears a threshold value, then the magnitude of the 3-phase current vector is reduced. The controller may also instruct the inverter to produce alternating use of 3-phase current vectors with different angular values.

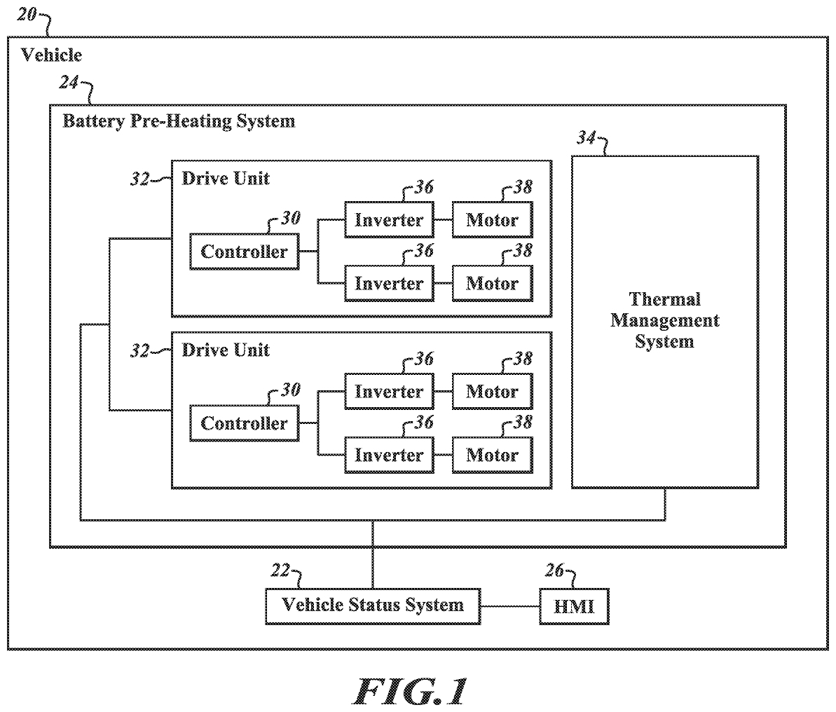

Referring now to FIG. 1, in various embodiments an illustrative vehicle 20 includes components for using electric motor control to operate without generating torque in order to generate heat for use in pre-heating batteries before vehicle use.

The illustrative vehicle 20 includes one or more drive units 32 that are in data communication with a vehicle status system 22 and in data and/or thermal communication with a thermal management system 34 and batteries (not shown) of the vehicle 20. In various embodiments, the drive unit 32 includes a controller 30, a pair of inverters 36, and a pair of AC motors 38. A first one of the inverters 36 provides a first 3-phase current motor drive signal to a first one of the AC motors 38. A second one of the inverters 36 provides a second 3-phase current motor drive signal to the second one of the AC motors 38. The inverters 36 generate the 3-phase current motor drive signals in response to instructions from the controller 30. The vehicle 20 may include additional drive units for controlling power to additional axles and/or wheels.

In various embodiments the vehicle 20 includes a battery pre-heating system 24. The battery pre-heating system 24 uses the one or more drive units 32 and the thermal management system 34 in order to heat vehicle batteries using heat generated by the drive units 32 before the vehicle 20 is commanded or scheduled for operation by an operator.

In various embodiments, the vehicle 20 includes a vehicle status system 22 and a human-machine interface device (HMI) 26. The thermal management system 34 determines when the batteries of the vehicle 20 are to be heated based on battery temperature information received from a battery temperature sensor (not shown). The HMI 26 receives input, such as a request to begin operating the vehicle 20 or a request to pre-heat the batteries, from the operator and sends that input to the vehicle status system 22.

It will be appreciated that heating the batteries may be desirable in various different scenarios. For example, in some embodiments the vehicle 20 may be located in a colder environment while being in a charging situation. In other embodiments, an operator of the vehicle 20 initiates a preoperational mode, which may include commanding the vehicle 20 via input received at the HMI 26 to heat the vehicle cabin as well as preparing batteries for full operation. This determination may request the thermal management system 34 to determine current battery temperature and determine if there is a need to heat the batteries. If there is a need to heat the batteries a heat request is sent to the drive units 32. In response to the drive units 32 receiving the heat request, the controllers 30 instruct the inverters 36 to send 3-phase current signals to the motors 38. The 3-phase current signals command the motors 38 to operate in a zero-torque mode. In the zero-torque mode, the motors 38 are functioning and generating heat, but are outputting zero torque. In the zero-torque mode, the motors 38 and/or the inverters 36 are generating heat.

Upon receiving the determination to heat the batteries or receiving notification that a battery pre-heat mode has begun, the thermal management system 34 controls transfer of heat from the drive units 32 to the batteries. This heat transfer may move a transfer fluid heated by the inverters 36 and/or the motors 38 to a location at or near the batteries, whereby heat from the heated transfer fluid is dissipated into the batteries. Examples of the thermal management system 34 may be a single, closed-loop system or may include components of a battery coolant system and/or a drive unit coolant system (that is, drivetrain coolant system). Once the batteries have reached a desired temperature, a signal is sent back to the thermal management system 34, the vehicle status system 22, and/or the drive units 32 instructing the battery pre-heating to stop.

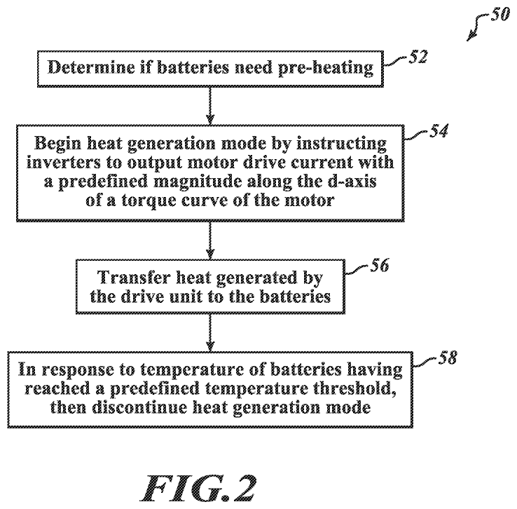

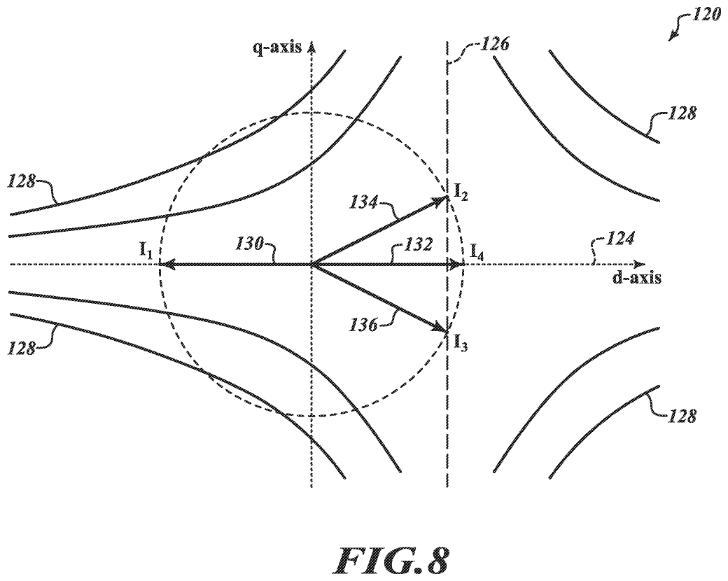

Referring additionally to FIG. 2, in various embodiments an illustrative process 50 is performed by the vehicle 20 for performing battery pre-heating. At a block 52, in response to instructions from the HMI 26, the vehicle status system 22 may request the thermal management system 34 to determine that a battery pre-heating mode is to commence based on battery temperature. At a block 54, the pre-heating mode begins by the controller(s) 30 instructing the inverters 36 to output a motor drive current with the predefined magnitude and an angular phase value that coincides with the d-axis on the dq-axis current plane for the motors 38 (see FIG. 8). The inverter instructions may be specific for each of the motors 38. The outputted motor drive current causes the motors 38 to operate in a zero-torque mode of operation, thereby generating heat but not any torque for rotating axels or wheels.

In geometric terms, the “d” and “q” axes are the single-phase representations of the flux contributed by the three separate sinusoidal phase quantities at the same angular velocity. The d-axis, also known as the direct axis, is the axis by which flux is produced by the permanent magnet. The q-axis, the quadrature axis, is the axis on which torque is produced. In simplistic terms, the d-axis is the main flux direction, while the q-axis is the main torque producing direction. FIG. 8 shows an illustrative graphical representation of these axes.

At a block 56, the heat generated by the motors 38 (as well as possible heat generated by the inverters 36) is transferred to the batteries by the thermal management system 34. At a block 58, in response to a battery temperature reaching a predefined temperature threshold or a time limit being reached, the drive units 32 are instructed to discontinue operating in the battery pre-heating mode. In various embodiments, the drive units 32 may be instructed to discontinue operating in the battery pre-heating mode, in response to receiving at the vehicle status system 22 signals that indicate that an operator of the vehicle 20 is initiating a driving mode or the heat request drops to zero.

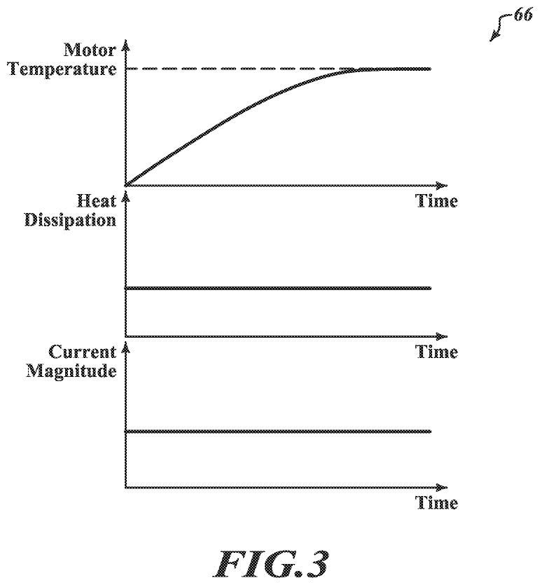

Referring additionally to FIG. 3, in various embodiments a graph 66 shows that during the battery pre-heating mode, the magnitude of the drive current is maintained at a constant value. This causes the temperature of the motors 38 to steadily increase over time. While the motor temperature of the motors 38 is steadily increasing, the heat dissipated and transferred to the batteries remains relatively constant.

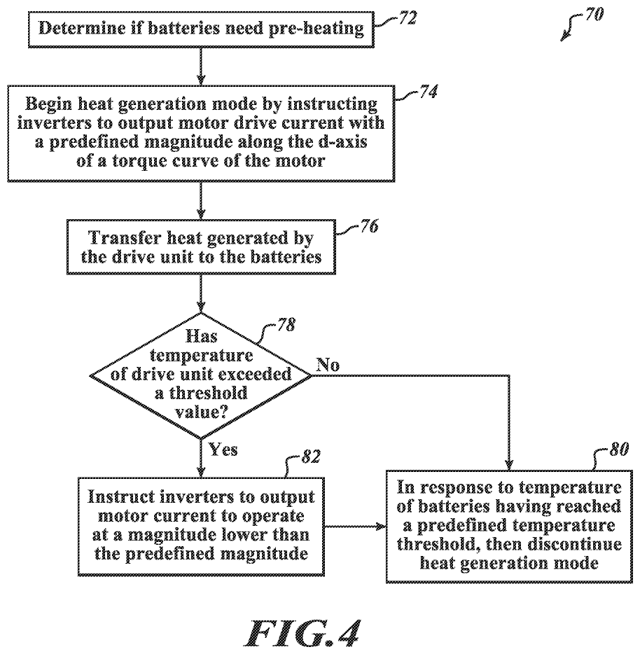

Referring additionally to FIG. 4, in various embodiments an illustrative process 70 is performed by the vehicle 20 for battery pre-heating. At a block 72, the vehicle status system 22 operates similar to the block 52 (FIG. 2). At a block 74, the pre-heating mode begins by the controller(s) 30 instructing the inverters 36 similar to the step at the block 54 (FIG. 2). At a block 76, the heat generated by the motors 38 (as well as possible heat generated by the inverters 36) is transferred to the batteries by the thermal management system 34. At a decision block 78, the controller(s) 30 determines if the inverters 36 and/or the motors 38 have reached or exceeded a predefined heat threshold value. If the inverters 36 and/or the motors 38 have not reached the heat threshold value, then at a block 80, in response to the batteries reaching a predefined temperature threshold, the drive units 32 are instructed to discontinue operating in the battery pre-heating mode. If the inverters 36 and/or the motors 38 have been determined to have reached the heat threshold value, then at a block 82, the inverters 36 are instructed by the controller(s) 30 to operate at a lower magnitude value than initially commanded. After the block 82, the process 70 proceeds to the block 80. In various embodiments, at any point in the process 70 the drive units 32 may be instructed to discontinue operating in the battery pre-heating mode, if signals are received indicating that an operator of the vehicle 20 is initiating a driving mode.

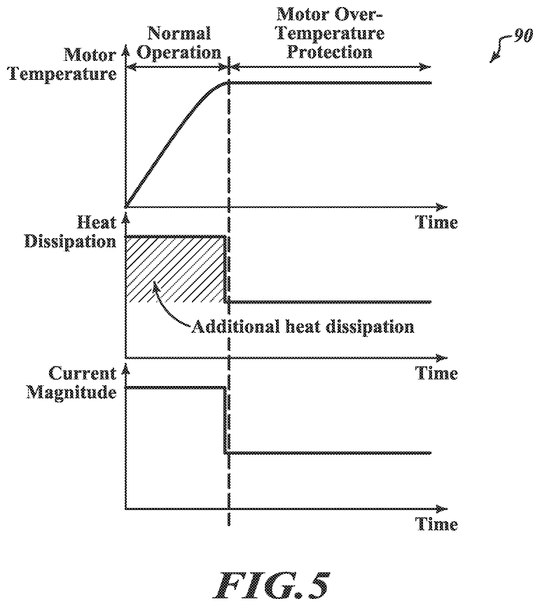

Referring additionally to FIG. 5, in various embodiments a graph 90 graphically illustrates heat and current values over time as a result of performance of the process 70 (FIG. 4). The graph 90 shows that during initial operation in the battery pre-heating mode the magnitude of the 3-phase current is at a first value that then gets reduced to a lower value after the temperature of the motors or the inverters have reached a predefined over-temperature value. After the change in 3-phase current magnitude, the heat dissipated by the motors reduces thus keeping the motors from overheating.

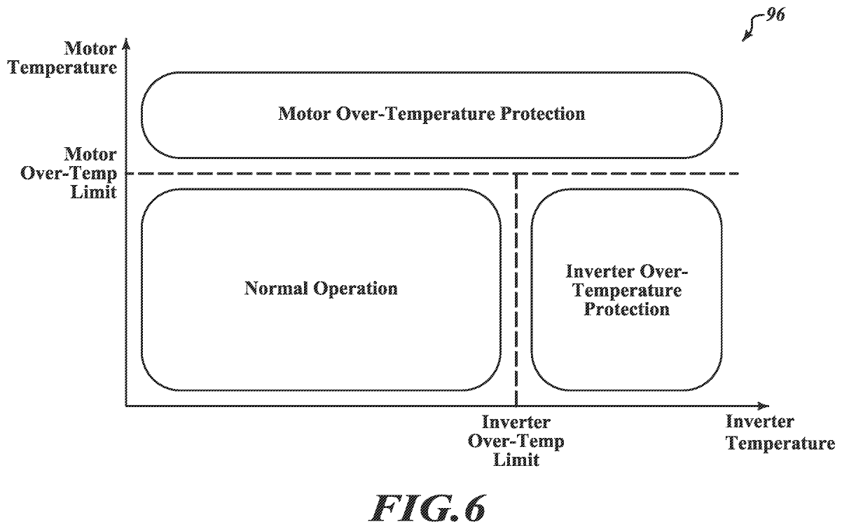

Referring additionally to FIG. 6, in various embodiments a graph 96 shows an illustrative correlation between how the process 70 (FIG. 4) operates relative to both a motor over-temperature limit and an inverter over-temperature limit.

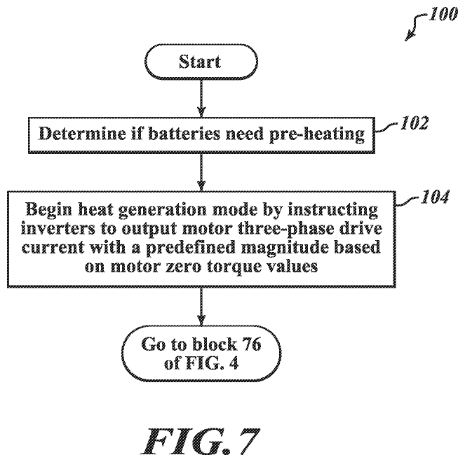

Referring additionally to FIG. 7, in various embodiments an illustrative process 100 is performed by the vehicle 20 for battery pre-heating. At a block 102, the vehicle status system 22 operates similar to the block 52 (FIG. 2). At a block 104, the pre-heating mode begins by the controller(s) 30 instructing the inverters 36 to output a 3-phase motor drive current with the predefined magnitude that has one of several different angular phase values (current vector). The current vector has a 3-phase vector direction that is based on zero motor torque values. The current vector may coincide with the d-axis of a torque curve for the motors 38 (see the block 74 of the process 70 (FIG. 4)) or the current vector may have other angular values that would produce zero torque as can be determined from a permanent magnet dq-axis current plane 120 (FIG. 8).

As shown in FIG. 8, four current vectors I₁, I₂, I₃, I₄ (130-136) have the same magnitude. Current vectors I₁, I₄ coincide with the d-axis 124. Current vectors I₂, I₃ have angular values that with their magnitude cause the current vectors I₂, I₃ to end at a second zero-torque line 126 that is parallel to the q-axis. The d-axis and the second zero-torque line 126 are considered zero-torque lines for the associated motor. The dq-axis current plane 120 also shows constant torque contours 128 for the permanent magnet motor (the motors 38).

In various embodiments, the outputted motor drive current causes the motors 38 to generate heat but not any torque for driving attached wheel axles. Then, the process 100 proceeds to the block 76 of FIG. 4.

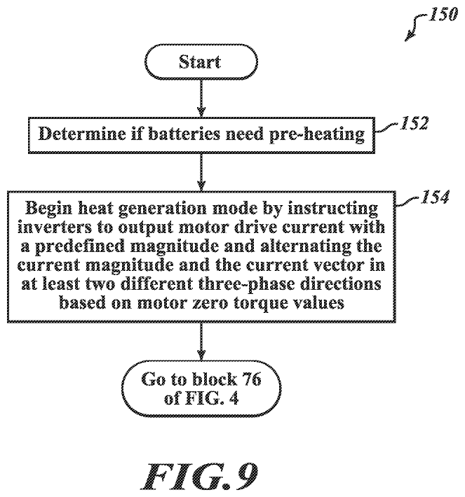

Referring additionally to FIG. 9, in various embodiments an illustrative process 150 is performed by the vehicle 20 for battery pre-heating. At a block 152, the vehicle status system 22 operates similar to the block 52 (FIG. 2). At a block 154, the pre-heating mode begins by the controller(s) 30 instructing the inverters 36 to output a motor 3-phase drive current with the predefined magnitude that has an angular phase value (current vector). The instruction from the controller(s) 30 causes the inverter 36 to alternate between two or more of the current vectors I₁, I₂, I₃, I₄ (130-136) (FIG. 8).

In various embodiments and as shown in Table 1 below, average current values are shown for an example of the process 100 (row 1) and for an example of the process 150 (row 2). Each of the columns represent a combination of the chosen current vector and the ration of time length each current vector is commanded

TABLE 1

| | Phase A | Phase B | Phase C |
|---|---|---|---|
| | Current | Current | Current |
| | Mean [A] | Mean [A] | Mean [A] |
| t₁:t₂:t₃:t₄ = 1:0:0:0 | −495.0 | 247.5 | 247.5 |
| t₁:t₂:t₃:t₄ = 0:1:1:0 | 340 | 311.6 | 311.6 |

In row 1, the current vector I₁ 130 has been selected from the possible current vectors I₂, I₃, I₄ (130-136). t is the time length during which a certain current vector is commanded. For example, t₁ indicates the time length I₁ is commanded. t₁:t₂:t₃:t₄ indicates the ratio of the time length of 4 different current vectors. In row 2, the current vectors alternate between I₂ 134 and I₃ 136. The alternating process shows a lower current value on one phase but a bit higher at the other two phases. This results in a more even distribution of temperatures among the 3-phase physical leads that connects between the inverter 36 and the motor 38. This may help contribute to reducing stress on the leads, the inverters 36, and the motors 38 during the pre-heating process.

The outputted motor drive current causes the motors 38 to generate heat but not any torque for driving attached wheel axles. The process 150 then proceeds to the block 76 (FIG. 4).

From the foregoing discussion and associated drawing figures, it will be appreciated that various embodiments have been disclosed and illustrated. To that end and without any implication of any limitation (which is not to be inferred), the following paragraphs set forth non-limiting summaries of various embodiments disclosed herein by way of example only and not of limitation:

A. A drive unit controller comprising: a first component configured receive to heat request and vehicle status information; and a second component configured to initiate a battery heat generation mode responsive to the received heat request and the vehicle status information.

B. The drive unit controller of A, further comprising: a third component configured to: generate a motor instruction responsive to the initiated battery heat generation mode; and send the motor instruction to an inverter of an associated drive unit, the motor instruction being configured to cause a motor commanded by the inverter to operate in a zero-torque mode of operation.

C. The drive unit controller of B, wherein the motor instruction includes a current magnitude value and a current vector direction value.

D. The drive unit controller of C, wherein the third component is further configured to generate the motor instruction based on operational parameters of the motor.

E. The drive unit controller of D, wherein the generated current vector direction value has an angular value located along a main flux direction associated with the motor.

F. The drive unit controller of A, further comprising: a fourth component configured to stop the battery heat generation mode responsive to at least one condition chosen from the generated battery temperature information being greater than a predefined value and the vehicle status information including a vehicle motion command.

G. The drive unit controller of C, further comprising: a fifth component configured to receive temperature information of the associated drive unit; and a sixth component configured to generate a second motor instruction including a reduced current magnitude value responsive to the temperature of the drive unit exceeding a threshold value.

H. The drive unit controller of G, wherein the temperature of the drive unit includes at least one temperature chosen from a temperature of the motor and a temperature of the inverter.

I. The drive unit controller of D, wherein the current vector direction value is based on zero-torque information for the motor.

J. The drive unit controller of I, further comprising: a seventh component configured to generate two or more of the motor instructions, a first one or more of the motor instructions having a current vector direction value with an angular value that differs from a main flux direction of the motor and a second one or more of the motor instructions having a current vector direction value with an angular value located along a main flux direction of the motor.

K. The drive unit controller of J, further comprising: an eighth component configured to alternate between the first one or more of the motor instructions and the second one or more of the motor instructions.

L. The drive unit controller of K, wherein the current magnitude value associated with each of the current vector direction values has a constant magnitude value.

M. A drive unit comprising: an electric motor; an inverter configured to control operation of the electric motor; and a drive unit controller including: a first component configured receive to a heat request and vehicle status information; and a second component configured to: generate a motor instruction responsive to the received heat request and the vehicle status information; and send the motor instruction to an inverter of an associated drive unit, the motor instruction being configured to cause a motor commanded by the inverter to operate in a zero-torque mode of operation.

N. The drive unit of M, wherein: the motor instruction includes a current magnitude value and a current vector direction value, the current vector direction value being based on zero-torque information for the motor; and the second component is further configured to generate the motor instruction based on operational parameters of the motor.

O. The drive unit of M, wherein the drive unit controller further includes: a third component configured to generate two or more of the motor instructions, a first one or more of the motor instructions having a current vector direction value with an angular value that differs from a main flux direction of the motor and a second one or more of the motor instructions having a current vector direction value with an angular value located along a main flux direction of the motor.

P. The drive unit of O, wherein the drive unit controller further includes: a fourth component configured to alternate between the first one or more of the motor instructions and the second one or more of the motor instructions.

Q. The drive unit of N, wherein the drive unit controller further includes: a fifth component configured to stop the battery heat generation mode responsive to at least one condition chosen from the generated heat request being less than a predefined value and the vehicle status information including a vehicle motion command; a sixth component configured to receive temperature information of the associated drive unit; and a seventh component configured to generate a second motor instruction including a reduced current magnitude value responsive to the temperature of the drive unit exceeding a threshold value.

R. A vehicle comprising: a vehicle status system configured to generate vehicle status information; a battery system configured to generate battery temperature information; a thermal management system configured to generate a heat request in response to the battery temperature information and transfer heat to the battery system; a drive unit configured to receive power from the battery system; a drive unit controller including: a first component configured to receive the heat request and vehicle status information; and a second component being configured to: generate a motor instruction responsive to the received heat request and the vehicle status information, the motor instruction including a current magnitude value and a current vector direction value; and send the motor instruction to an inverter of an associated drive unit, the motor instruction being configured to cause a motor commanded by the inverter to operate in a zero-torque mode of operation.

S. The vehicle of R, wherein: the drive unit further includes: an inverter couplable to the battery system, the inverter being configured to generate 3-phase drive signals based on the current magnitude value and the current vector direction value of the zero-torque instruction; and a motor configured to operate based on the generated 3-phase drive signals; and the drive unit controller further includes a third component configured to generate the motor instruction based on parameters of the drive unit in order for at least one component chosen from the inverter and the motor to generate a predefined heat value and the motor to operate in a zero-torque condition.

T. The system of S, wherein the drive unit controller further includes: a fourth component configured to generate two or more of the motor instructions, a first one or more of the motor instructions having a current vector direction value with an angular value that differs from a main flux direction of the motor and a second one or more of the motor instructions having a current vector direction value with an angular value coinciding with a main flux direction of the motor.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

1. A drive unit controller, comprising:
a first component configured to receive heat request and vehicle status information;
a second component configured to initiate a battery heat generation mode responsive to the received heat request and the vehicle status information; and
a third component configured to:
generate a motor instruction responsive to the initiated battery heat generation mode, the motor instruction comprising a current magnitude value; and
send the motor instruction to an inverter of a drive unit, the motor instruction being configured to cause a motor associated with the inverter to operate in a zero-torque mode of operation,
wherein the drive unit controller is configured to receive temperature information of the drive unit and generate a second motor instruction comprising a reduced current magnitude value responsive to the temperature of the drive unit exceeding a threshold value.

2. (canceled)

3. (canceled)

4. The drive unit controller of claim 1, wherein the third component is further configured to generate the motor instruction based on operational parameters of the motor.

5. The drive unit controller of claim 4, wherein a generated current vector direction value of the motor instruction has an angular value located along a main flux direction associated with the motor.

6. The drive unit controller of claim 1, further comprising:
a fourth component configured to stop the battery heat generation mode responsive to at least one condition chosen from the heat request dropped to zero and the vehicle status information comprising a vehicle motion command.

7. The drive unit controller of claim 1, further comprising:
a fifth component configured to receive the temperature information of the drive unit; and
a sixth component configured to generate the second motor instruction comprising the reduced current magnitude value responsive to the temperature of the drive unit exceeding the threshold value.

8. The drive unit controller of claim 7, wherein the temperature of the drive unit comprises at least one temperature chosen from a temperature of the motor and a temperature of the inverter.

9. The drive unit controller of claim 5, wherein the current vector direction value is based on zero-torque information for the motor.

10. The drive unit controller of claim 9, further comprising:
a seventh component configured to generate two or more of the motor instructions, a first one or more of the motor instructions having a current vector direction value with an angular value that differs from a main flux direction of the motor and a second one or more of the motor instructions having a current vector direction value with an angular value located along a main flux direction of the motor.

11. The drive unit controller of claim 10, further comprising:
an eighth component configured to alternate between the first one or more of the motor instructions and the second one or more of the motor instructions.

12. The drive unit controller of claim 11, wherein the current magnitude value associated with each of the current vector direction values has a constant magnitude value.

13. A drive unit comprising:
an electric motor;
an inverter configured to control operation of the electric motor; and
a drive unit controller comprising:
a first component configured receive to heat request and vehicle status information; and
a second component configured to:
generate a motor instruction responsive to the received heat request and the vehicle status information, the motor instruction comprising a current magnitude value; and
send the motor instruction to an inverter of the drive unit, the motor instruction being configured to cause a motor associated with the inverter to operate in a zero-torque mode of operation,
wherein the drive unit controller is configured to receive temperature information of the drive unit and generate a second motor instruction comprising a reduced current magnitude value responsive to the temperature of the drive unit exceeding a threshold value.

14. The drive unit of claim 13, wherein:
a current vector direction value of the motor instruction is based on zero-torque information for the motor; and
the second component is further configured to generate the motor instruction based on operational parameters of the motor.

15. The drive unit of claim 14, wherein the drive unit controller further comprises:
a third component configured to generate two or more of the motor instructions, a first one or more of the motor instructions having a current vector direction value with an angular value that differs from a main flux direction of the motor and a second one or more of the motor instructions having a current vector direction value with an angular value located along a main flux direction of the motor.

16. The drive unit of claim 15, wherein the drive unit controller further comprises:
a fourth component configured to alternate between the first one or more of the motor instructions and the second one or more of the motor instructions.

17. The drive unit of claim 13, wherein the drive unit controller further comprises:
a fifth component configured to stop the battery heat generation mode responsive to at least one condition chosen from the generated heat request being greater than a predefined value and the vehicle status information comprising a vehicle motion command;
a sixth component configured to receive the temperature information of the drive unit; and
a seventh component configured to generate the second motor instruction comprising the reduced current magnitude value responsive to the temperature of the drive unit exceeding the threshold value.

18. A vehicle, comprising:
a vehicle status system configured to generate vehicle status information;
a battery system configured to generate battery temperature information;
a thermal management system configured to generate a heat request in response to the battery temperature information and transfer heat to the battery system;
a drive unit configured to receive power from the battery system; and
a drive unit controller comprising:
a first component configured to receive the heat request and vehicle status information; and
a second component being configured to:
generate a motor instruction responsive to the initiated battery heat generation mode, the motor instruction comprising a current magnitude value; and
send the motor instruction to an inverter of a drive unit, the motor instruction being configured to cause a motor associated with the inverter to operate in a zero-torque mode of operation,
wherein the drive unit controller is configured to receive temperature information of the drive unit and generate a second motor instruction comprising a reduced current magnitude value responsive to the temperature of the drive unit exceeding a threshold value.

19. The vehicle of claim 18, wherein:
the drive unit further comprises:
the inverter couplable to the battery system, the inverter being configured to generate 3-phase drive signals based on the current magnitude value and a current vector direction value of the zero-torque mode of operation; and
the motor configured to operate based on the generated 3-phase drive signals; and
the drive unit controller further comprises a third component configured to generate the motor instruction based on parameters of the drive unit in order for at least one component chosen from the inverter and the motor to generate a predefined heat value and the motor to operate in a zero-torque condition.

20. The system of claim 19, wherein the drive unit controller further comprises:
a fourth component configured to generate two or more of the motor instructions, a first one or more of the motor instructions having a current vector direction value with an angular value that differs from a main flux direction of the motor and a second one or more of the motor instructions having a current vector direction value with an angular value coinciding with a main flux direction of the motor.
